(19) United States
(12) Patent Application Publication
(10) Pub. No.: US 2006/0201731 A1
(43) Pub. Date: Sep. 14, 2006

(54) Airbag for protecting pedestrian or the like, and airbag device for protecting pedestrian or the like

(75) Inventor: Atsushi Nakamura, Minatu-ku (JP)

Correspondence Address: FITCH EVEN TABIN AND FLANNERY, 120 SOUTH LA SALLE STREET, SUITE 1600, CHICAGO, IL, 60603-3406, US

(73) Assignee: Takata Corporation, Minatu-ku (JP)

(21) Appl. No.: 11/352,618

(22) Filed: Feb. 13, 2006

(30) Foreign Application Priority Data
Mar. 9, 2005 (JP) 2005-066017

(51) Int. Cl. B60R 21/34

(52) U.S. Cl. 180/274

(57) ABSTRACT

An airbag for protecting a pedestrian or the like and an airbag device for protecting a pedestrian or the like including the airbag are disclosed. The airbag is quickly deployed to a predetermined deployment area without the use of a high output inflator and has a high absorption property of impact which is applied to the pedestrian or the like. In one form, an airbag for protecting a pedestrian or the like comprises a lower side portion provided so as to extend along a cowl top, left and right side portions and provided so as to extend along left and right A pillars, respectively, and an upper side portion connecting top portions of the left and right side portions. A horizontally central portion of the upper side portion is connected to the left and right side portions by small flow path cross-sectional portions. When the airbag is inflated, introduction of gas to the upper side portion from the left side portion and the right side portion is restricted, so that the internal pressures of the lower side portion, the left side portion, and the right side portion become high early. Thereafter, the gas gradually flows to the upper side portion, so that the internal pressure of the entire airbag is relatively low.

### FIELD OF THE INVENTION

The present invention relates to an airbag for protecting a pedestrian or the like and an airbag device for protecting a pedestrian or the like including the airbag. The airbag prevents a pedestrian or a person riding, for example, a bicycle or a motorcycle (hereunder referred to as “pedestrian or the like”) from directly bumping into, for example, a highly rigid portion, such as a pillar of a vehicle body, by being inflated along the outer surface of the vehicle body when a running vehicle collides with, for example, a pedestrian, a bicycle, or a motorcycle.

### BACKGROUND OF THE INVENTION

When a running vehicle collides with, for example, a pedestrian, a bicycle, or a motorcycle, the lower part of the body of the pedestrian or the like with which the vehicle has collided may be knocked away by the front portion of the vehicle, thrown up onto a hood covering the top surface of the front portion of the vehicle body, and undergo secondary collision with, for example, a highly rigid portion such as a pillar.

FIG. 10 in Japanese Unexamined Patent Application Publication No. 2000-264146 illustrates a protection device which protects a pedestrian or the like by preventing the pedestrian or the like from directly bumping into a portion near a cowl top, an A pillar, and the front edge of a roof as a result of inflating an airbag along the periphery of a windshield of a vehicle when the vehicle has collided with the pedestrian or the like.

FIG. 6 is a perspective view of the protection device shown in FIG. 10 in the same document.

As shown in FIG. 6, the protection device shown in FIG. 10 in the same document includes an airbag 110 which is inflated in the form of a rectangular frame so as to surround the entire periphery of a windshield 101 of a vehicle 100.

The airbag 110 has a lower side portion 111 which is deployed horizontally along a cowl top 102, a left side portion 112 and a right side portion 113 which are deployed vertically along left and right A pillars 103 and 103, respectively, and an upper side portion 114 which is deployed horizontally along the front edge of a roof 104. A gas inlet (not shown) for introducing gas from an inflator (not shown) is provided near a horizontal longitudinal center of the lower side portion 111.

The airbag 110 is folded and disposed at the lower side (the back side) of the rear portion of a bonnet hood 105.

When the vehicle collides with a pedestrian or the like, the inflator ejects gas, so that deployment of the airbag 110 is started. Here, since the gas from the inflator is supplied to the lower side portion 111, first, the lower side portion 111 pushes up the bonnet hood 105 and is inflated towards the outer surface of the vehicle body, so that it is deployed in horizontal direction along the cowl top 102.

Next, from the lower side portion 111, the gas flows to the left side portion 112 and the right side portion 113, so that the left side portion 112 and the right side portion 113 are deployed so as to expand upward along the left and right A pillars 103, respectively. Since the top portion of the left side portion 112 and the top portion of the right side portion 113 are connected by the upper side portion 114, fluttering of the left side portion 112 and the right side portion 113 when they are deployed is prevented or restricted.

The deployment of the left side portion 112 and the right side portion 113 causes the upper side portion 114 to be placed along the front edge of the roof 104 as the upper side portion 114 is pulled horizontally, and the gas to flow to the upper side portion 114 from the left side portion 112 and the right side portion 113, causing the upper side portion 114 to be inflated.

In the protection device for a pedestrian or the like shown in FIG. 10 in Japanese Unexamined Patent Application Publication No. 2000-264146, in order to quickly deploy the airbag 110 to a predetermined deployment area, it is necessary for the gas to quickly go around the entire airbag 110. To achieve this, a high output inflator may be used, but, in this case, the internal pressure of the deployed airbag may become excessively high.

### SUMMARY OF THE INVENTION

An object of the present invention is to provide an airbag for protecting a pedestrian or the like and an airbag device for protecting a pedestrian or the like including the airbag. The airbag is quickly deployed to a predetermined deployment area without the use of a high output inflator and has a high absorption property of impact which is applied to the pedestrian or the like.

According to one form of the invention, there is provided an airbag for protecting a pedestrian or the like. The airbag comprises a lower side portion provided so as to extend along a cowl top of a vehicle, left and right side portions provided so as to extend along left and right pillars, respectively, and an upper side portion connecting top portions of the left and right side portions. At least a horizontally central portion of the upper side portion is connected to the left and right side portions through small flow path cross-sectional portions.

The airbag for protecting a pedestrian or the like according to a preferred form of the invention is characterized in that, in the one form, a portion between the small flow path cross-sectional portions at the upper side portion is provided with a vent hole.

According to another form of the invention, there is provided an airbag device for protecting a pedestrian or the like. The airbag device comprises an airbag for protecting a pedestrian or the like, and an inflator. The airbag comprises a lower side portion provided so as to extend along a cowl top of a vehicle, left and right side portions provided so as to extend along left and right pillars, respectively, and an upper side portion connecting top portions of the left and right side portions. The inflator supplies gas to the lower side portion. The airbag for protecting a pedestrian or the like is the airbag for protecting a pedestrian or the like of either of the above-described forms.

In the airbag for protecting a pedestrian or the like and the airbag device for protecting a pedestrian or the like according to the present invention, when a collision between the pedestrian or the like and a vehicle is detected or predicted, the inflator operates, thereby starting the inflation of the airbag. In this case, gas from the inflator is supplied to the lower side portion of the airbag, so that, first, the lower side portion is inflated and deployed along the cowl top.

Next, from the lower side portion, the gas flows to the left side portion and the right side portion, so that the left side portion and the right side portion are inflated and deployed so as to expand upward along the left and right pillars, respectively. Since the top portion of the left side portion and the top portion of the right side portion are connected by the upper side portion, fluttering of the left side portion and the right side portion when they are deployed is prevented or restricted.

The deployment of the left side portion and the right side portion causes the upper side portion to be placed near the front edge of a roof as the upper side portion is pulled horizontally.

In the present invention, since the upper side portion is connected to the left and right side portions through the small flow path cross-sectional portions, the introduction of gas to the upper side portion from the left side portion and the right side portion is restricted. Therefore, the internal pressures of the lower side portion, the left side portion, and the right side portion become high early, so that they are quickly deployed along the cowl top and the left and right pillars, respectively.

Thereafter, the gas gradually passes through each small flow path cross-sectional portion and flows to the upper side portion from the left side portion and the right side portion, thereby reducing the internal pressures of the lower side portion, the left side portion, and the right side portion, so that, finally, the internal pressures of the lower side portion, the left side portion, the right side portion, and the upper side portion all become substantially equal. As a result, the internal pressure of the entire airbag becomes relatively low, so that, when a pedestrian or the like collides with the airbag, a sufficient stroke occurs. Therefore, impact that is applied to the pedestrian or the like is absorbed.

When a vehicle collides with a pedestrian or the like at a relatively high speed (such as 30 to 40 km/h), the pedestrian or the like may collide with the lower side portion, the left side portion, and the right side portion when the internal pressures of these portions are high. In this case, when the pedestrian or the like pushes these portions, discharging of gas towards the upper side portion is accelerated. The discharging of the gas towards the upper side portion causes impact that is applied to the pedestrian or the like to be sufficiently absorbed.

As in the preferred form of the invention, a vent hole formed at the portion between the small flow path cross-sectional portions at the upper side portion makes it possible, not only to reduce the speed of deployment of the airbag, but also to further increase an absorption property of impact which is applied to the pedestrian or the like.

### BRIEF DESCRIPTION OF THE DRAWINGS

FIGS. 1(a) and 1(b) are perspective views of a vehicle including a protection device for a pedestrian or the like according to an embodiment.

FIG. 2 is a sectional view taken along line II-II shown in FIG. 1(b).

FIG. 3 is a plan view of an airbag shown in FIG. 1(b).

FIG. 4 is a plan view of an airbag of another embodiment.

FIG. 5 is a plan view of an airbag, showing an example of a disposition of a vent hole.

FIG. 6 is a perspective view of a vehicle including a protection device for a pedestrian or the like explaining an example of a conventional airbag.

### DETAILED DESCRIPTION OF THE PREFERRED EMBODIMENTS

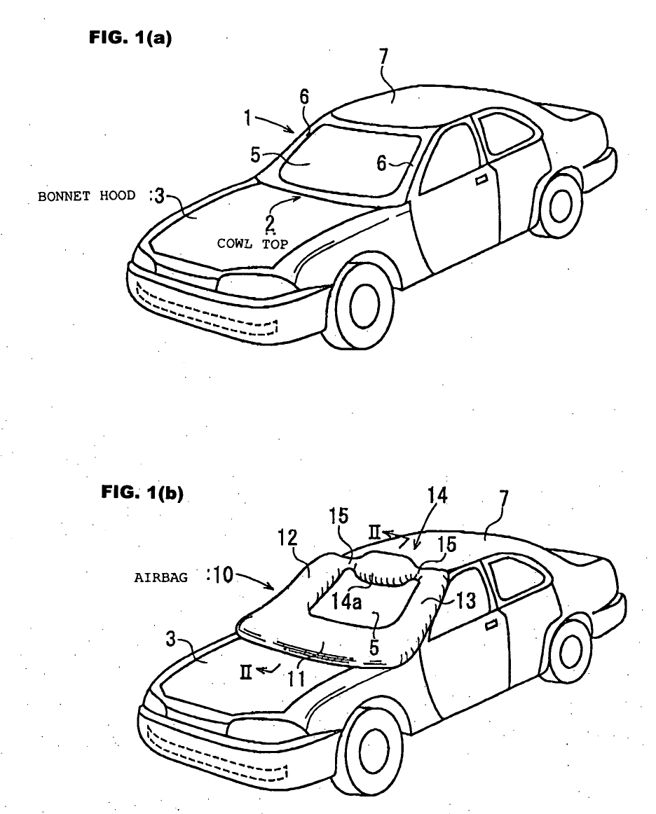

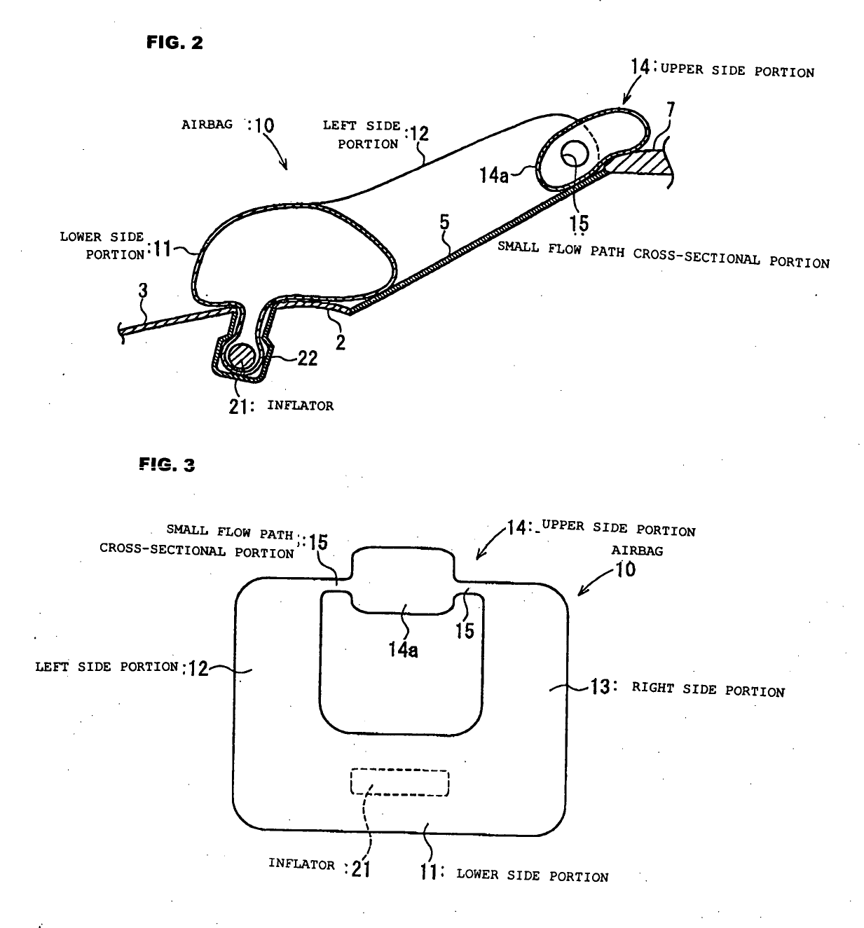

Embodiments will hereunder be described with reference to the drawings. FIGS. 1(a) and 1(b) are perspective views of a vehicle including a protection device for a pedestrian or the like according to an embodiment. FIG. 2 is a sectional view taken along line II-II shown in FIG. 1(b), and FIG. 3 is a plan view of an airbag.

In FIG. 1(a), a vehicle 1 is a four-door sedan, but the present invention is not limited thereto. An airbag device for protecting a pedestrian or the like by inflating and deploying an airbag 10 for protecting a pedestrian or the like along the periphery of a windshield 5 during collision with the pedestrian or the like is disposed at a cowl top 2 or the rear portion of a bonnet hood 3. (The airbag protecting a pedestrian or the like may hereunder be simply referred to as the “airbag.”)

The airbag device for protecting a pedestrian or the like comprises the airbag 10, an inflator 21 for supplying gas to the airbag 10, a case 22 accommodating the folded airbag 10 and the inflator 21, and a cover (not shown) which usually covers the case 22 and which opens when the airbag 10 is inflated. The cover may form an outer surface of the vehicle body. The airbag for protecting a pedestrian or the like is disposed at the lower side of the rear portion of the bonnet hood 3, and pushes open the rear portion of the bonnet hood 3 when the airbag 10 is inflated.

As shown in FIG. 1(b), the airbag 10 has the shape of rectangular frame and has a lower side portion 11 extending along the cowl top 2, a left side portion 12 and a right side portion 13 extending along left and right A pillars 6 and 6, respectively, and an upper side portion 14 connecting the top portion of the left side portion 12 and the top portion of the right side portion 13. The inflator 21 is disposed in the lower side portion 11.

In the present invention, small flow path cross-sectional portions 15 having flow path cross-sectional areas that are smaller than those of the left side portion 12, the right side portion 13, and a horizontally central portion 14a of the upper side portion 14 are formed at respective horizontal ends of the upper side portion 14. The terms “flow path cross-sectional area” refer to an opening area in cross-section in a direction perpendicular to a direction of distribution of gas or a direction of extension of each part of the airbag.

In the embodiment, as shown in FIG. 3, the small flow path cross-sectional portions 15 are formed so as to narrow down both ends of the upper side portion 14 into the form of a small-diameter tube. In the embodiment, each small flow path cross-sectional portion 15 has one end formed consecutively with the top end of its associated left side portion 12 or right side portion 13, and its other end formed consecutively near a vertical intermediate portion of its associated side of the central portion 14a. However, the disposition and the structure of the small flow path cross sectional portions are not limited thereto.

The flow path cross-sectional area of each small flow path cross-sectional portion 15 is desirably 0.5 to 20% and, more desirably, 1 to 10% of the average flow path cross-sectional area of each of the left side portion 12 and the right side portion 13. The volume of the central portion 14a is desirably 5 to 50%, and, more desirably, 10 to 30% of the total of the volumes of the lower side portion 11, the left side portion 12, and the right side portion 13.

Next, the operation of the airbag device including the airbag 10 having such a structure will be described.

When a collision between a pedestrian or the like and the vehicle 1 is detected or predicted, the inflator 21 ejects gas, thereby starting the inflation of the airbag 10. In this case, the gas from the inflator 21 is supplied to the lower side portion 11 of the airbag 10, so that, first, the lower side portion 11 is inflated and deployed along the cowl top 2.

Next, from the lower side portion 11, the gas flows to the left side portion 12 and the right side portion 13, so that the left side portion 12 and the right side portion 13 are inflated and deployed so as to expand upward along the left and right A pillars 6 and 6, respectively. Since the top portion of the left side portion 12 and the top portion of the right side portion 13 are connected by the upper side portion 14, fluttering of the left side portion 12 and the right side portion 13 when they are deployed is prevented or restricted.

The deployment of the left side portion 12 and the right side portion 13 causes the upper side portion 14 to be placed near the front edge of the roof 7 as the upper side portion 14 is pulled horizontally.

In the airbag 10, since the upper side portion 14 (central portion 14a) is connected to the left and right side portions 12 and 13 through the small flow path cross-sectional portions 15, the introduction of gas to the upper side portion 14 from the left side portion 12 and the right side portion 13 is restricted. Therefore, even if the inflator 21 has a relatively low output, the internal pressures of the lower side portion 11, the left side portion 12, and the right side portion 13 become high early, so that they are quickly deployed along the cowl top 2 and the left and right A pillars 6 and 6, respectively.

Thereafter, the gas gradually passes through each small flow path cross-sectional portion 15 and flows to the upper side portion 14 from the left side portion 12 and the right side portion 13, thereby reducing the internal pressures of the lower side portion 11, the left side portion 12, and the right side portion 14, so that, finally, the internal pressures of the lower side portion 11, the left side portion 12, the right side portion 13, and the upper side portion 14 all become substantially equal. As a result, the internal pressure of the entire airbag 10 becomes relatively low, so that, when a pedestrian or the like collides with the airbag 10, a sufficient stroke occurs. Therefore, impact that is applied to the pedestrian or the like is absorbed.

When the vehicle 1 collides with a pedestrian or the like at a relatively high speed (such as 30 to 40 km/h), the pedestrian or the like may collide with the lower side portion 11, the left side portion 12, and the right side portion 13 when the internal pressures of these portions are high. In this case, when the pedestrian or the like pushes these portions, discharging of gas towards the upper side portion 14 is accelerated. The discharging of the gas towards the upper side portion 14 causes impact that is applied to the pedestrian or the like to be sufficiently absorbed.

The embodiment is only one form of the present invention, so that the present invention is not limited to the embodiment.

For example, the disposition of the small flow path cross-sectional portions 15 is not limited to that shown in FIG. 3. FIG. 4 is a plan view of an airbag, showing another example of the disposition of small flow path cross-sectional portions 15. In an airbag 10A shown in FIG. 4, each small flow path cross-sectional portion 15 has one end formed consecutively with the top end of its associated left side portion 12 or right side portion 13, and its other end formed consecutively with the lower portion of its associated side of the central portion 14a of the upper side portion 14. Obviously, the disposition of the small flow path cross sectional portions 15 is not limited thereto.

Although, in the embodiment, the small flow path cross-sectional portions 15 are formed so as to narrow down both ends of the upper side portion 14, the structure of the small flow path cross-sectional portions 15 is not limited thereto. For example, although not illustrated, it is possible to form openings having small flow path cross-sectional areas in walls formed between the upper side portion 14 and the left and right side portions 12 and 13.

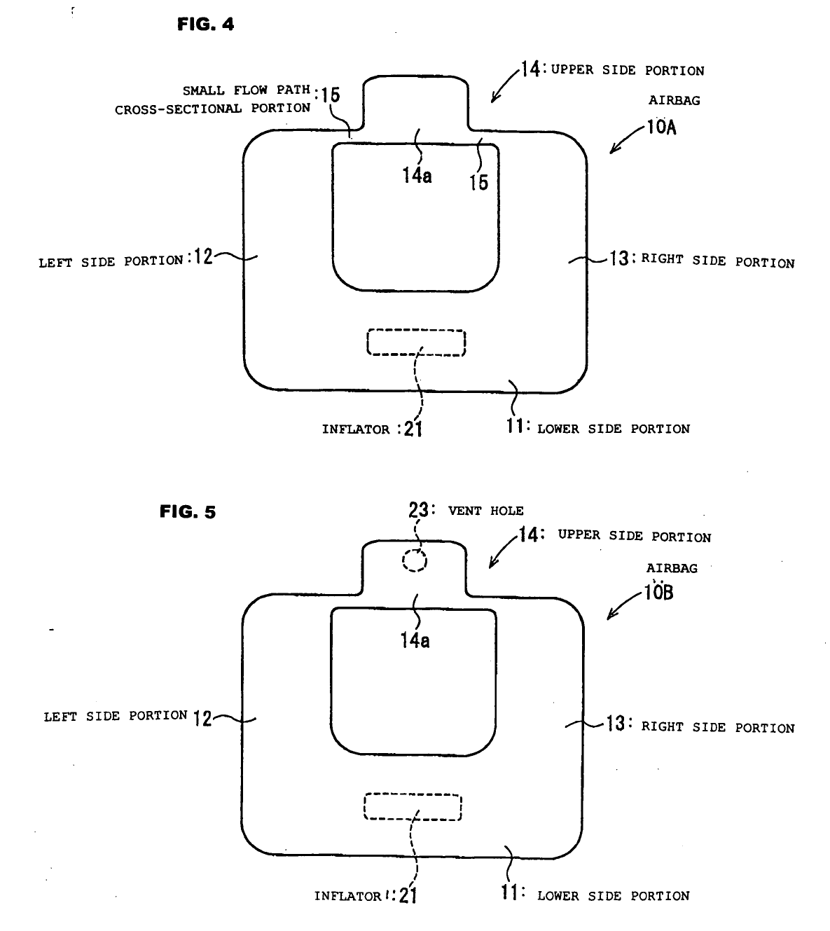

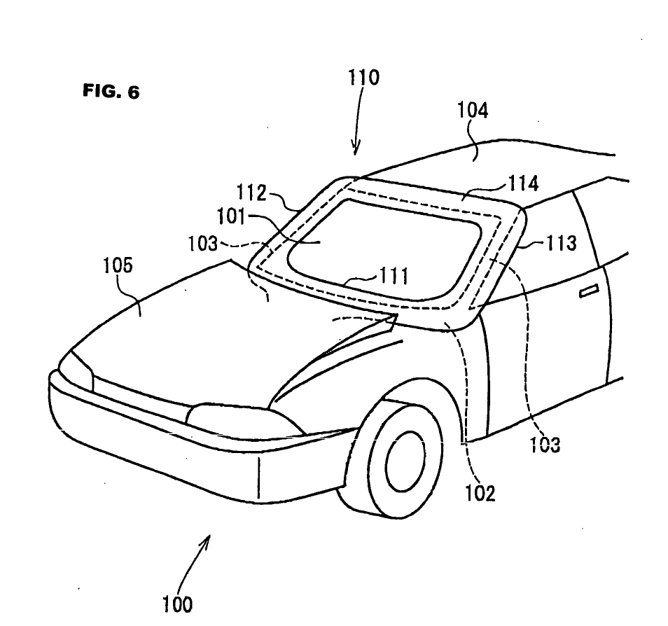

In the present invention, a vent hole may be formed in the airbag. In this case, as shown in an airbag 10B shown in FIG. 5, it is desirable to dispose a vent hole 23 in a horizontally central portion 14a of an upper side portion 14, that is, a portion between small flow path cross-sectional portions 15 and 15.

By virtue of such a structure, at an early stage of inflation of the airbag 10B, the discharge of gas from the vent hole 23 is small, so that the internal pressures of a lower side portion 11, a left side portion 12, and a right side portion 13 quickly become high. Therefore, the airbag 10B is quickly deployed. In addition, when a pedestrian or the like collides with the inflated airbag 10B, the gas is discharged from the vent hole 23 to the outside of the airbag 10B, so that impact that is applied to the pedestrian or the like is further absorbed.

FIG. 5 shows an example of the disposition of the vent hole, and the position and numbers of vent holes are not limited thereto.

What is claimed is:

1. An airbag for being deployed and inflated about the periphery of a windshield of a vehicle, the airbag comprising:
side portions that are inflated to generally extend upwardly along corresponding side portions of the windshield;
a lower portion that is inflated to generally extend laterally across a corresponding lower portion of the windshield and that is connected to both of the side portions;
an upper portion that is inflated to generally extend laterally across a corresponding upper portion of the windshield and that is connected to both of the side portions; and
small flow path cross-sectional portions that restrict gas flow from the side portions to the upper portion.

2. The airbag of claim 1 wherein the small flow cross-sectional portions have flow path cross-sectional areas smaller than that of the side portions.

3. The airbag of claim 1 wherein the small cross-sectional portions have flow path cross-sectional areas that are in the range of approximately 0.5% to approximately 20% of average flow path cross-sectional areas of each of the side portions.

4. The airbag of claim 1 wherein the upper portion includes a central portion that is enlarged relative to the small flow path cross-sectional portions.

5. The airbag of claim 4 wherein the enlarged central portion has a volume that is in the range of approximately 5% to approximately 50% of a total of volumes of the side portions and lower portion.

6. The airbag of claim 1 wherein the upper portion includes a central portion, and the small flow cross-sectional portions have flow path cross-sectional areas smaller than that of the central portion.

7. The airbag of claim 1 wherein the small flow path cross-sectional portions are small diameter tubes at either end of the upper portion.

8. The airbag of claim 1 including a vent between the small flow path cross-sectional portions.

9. The airbag of claim 8 wherein the upper portion includes an enlarged central portion between the small flow path cross-section portions and in which the vent is formed.

10. The airbag of claim 1 wherein the upper portion includes the small flow path cross-sectional portions so that the small flow path cross-sectional portions are inflated to generally extend laterally across the upper portion of the windshield.

11. An airbag device for a vehicle having a windshield, pillars on either side of the windshield, a cowl or hood extending forwardly from a bottom of the windshield, and a hood extending rearwardly from a front edge thereof adjacent a top of the windshield, the airbag device comprising:
an airbag for being deployed from below the cowl or hood to predetermined positions about the windshield;
side portions of the airbag that are inflated to substantially cover the pillars;
a lower portion of the airbag that is inflated to substantially cover a portion of the hood or cowl adjacent the bottom of the windshield;
an upper portion of the airbag that is inflated to substantially cover the front edge of the roof;
an inflator for supplying inflation gas to the airbag lower portion which flows into the side portions from the lower portion and the upper portion from at least one of the side portions; and
at least one restriction portion of the airbag that restricts inflation gas flow from the at least one side portion to the upper portion for rapid inflation of the lower and side portions.

12. The airbag device of claim 11 wherein the at least one restriction portion comprises a pair of restriction portions that restrict inflation gas flow from the side portions to the upper portion.

13. The airbag device of claim 11 wherein the restriction portion has a flow path cross-sectional area taken in a direction generally perpendicular to gas flow therein that is smaller than cross-sectional areas of the side portions.

14. The airbag device of claim 11 wherein the restriction portion is at one end of the upper portion.

15. The airbag device of claim 14 wherein the at least one restriction portion comprises a pair of restriction portions with the one restriction portion at the one end of the upper portion and the other restriction portion at an opposite end of the upper portion.

16. The airbag device of claim 11 wherein the at least one restriction portion comprises a pair of restriction portions, and the upper portion includes an enlarged central portion that narrow down to the restriction portions.

17. The airbag device of claim 16 wherein the enlarged central portion has upper and lower sides, and the restriction portions interconnect to the central portion intermediate the upper and lower sides thereof.

18. The airbag device of claim 16 wherein the enlarged central portion has upper and lower sides, and the restriction portions interconnect to the central portion generally at the lower side thereof.

19. The airbag device of claim 11 wherein the upper portion includes an enlarged portion and a vent opening in the enlarged portion.

20. The airbag device of claim 11 wherein the inflator is disposed in the airbag lower portion.
